(19) United States
(12) Patent Application Publication
(10) Pub. No.: US 2001/0036197 A1
(43) Pub. Date: Nov. 1, 2001

(54) Adapter apparatus and network system using the same

(75) Inventor: Motofumi Kakiuchi, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/840,962

(22) Filed: Apr. 25, 2001

(30) Foreign Application Priority Data
Apr. 27, 2000 (JP) 2000-127065

(51) Int. Cl. H04J 3/16; H04J 3/22

(52) U.S. Cl. 370/466

(57) ABSTRACT

Adapters 10 and 11 implement a mutual conversion of a protocol of a voice signal and a control signal over a telephone network, and voice data and control data over a LAN 30 that are converted into the packet. Thereby, existing digital multi function telephones 40 to 42 and a PBX 20 can be connected to the LAN, and all kinds of the services of utilizing the PBX 20 of the existing multi function telephones in the situation of having been connected to the LAN 30.

### BACKGROUND OF THE INVENTION

The present invention relates to an adapter apparatus and a network system using the same, and more particularly to an adapter apparatus that is used at the time of connecting a telephone to a local area network (LAN), and a network system using the same that is called a LAN telephone system.

Conventionally, in the LAN telephone system it has been carried out that telephones are connected in a LAN, and LAN terminals such as a personal computer (PC) and so forth are caused to have a telephone function.

FIG. 9 illustrates a system arrangement diagram of an example of the conventional network system that is called a LAN telephone system.

In the same FIG., a LAN 30 is connected to a LAN terminal 50 having a computer capability, and at the same time it is connected to a private branch exchange (PBX) 20 via an adapter 16 and a digital multiple signal line 60. Also, to the PBX 20 is connected a multi function telephone 41 via a digital multiple signal line 61. An adapter 16 implements a protocol conversion of signals between the LAN 30 and the PBX 20.

Next, a summary of an operation of this conventional system will be explained, the case being taken as an example in which an originating process to the LAN terminal 50 is executed by the multi function telephone 41. In this case, at first, an operator of the multi function telephone 41 picks up an ear receiver of the multi function telephone 41 to cause it to be in an off-hook situation. By this off-hook, the multi function telephone 41 transfers originating call information to the PBX 20 through the digital multiple signal line 61. The PBX 20 that got the originating call information outputs a dial tone (DT) to the digital multiple signal line 61.

Continually, the operator of the multi function telephone 41 pushes a button down to input a telephone number of the LAN terminal 50. This telephone number information is transferred to the PBX 20 through the digital multiple signal line 61. The PBX 20 that got this dialed telephone number information outputs to the digital multiple signal line 61 a ring-back tone (RBT) for the multi function telephone 41, and outputs to the digital multiple signal line 60 a ringing signal for the LAN terminal 50.

The ringing signal output to the digital multiple signal line 60 is input into the adapter 16, and the data of the ringing signal is converted into a packet, which is sent to the LAN 30. The LAN terminal 50 gets the packet of the ringing signal through the LAN 30 to execute a regeneration process of the ringing tone from the data of the ringing signal within this packet.

The operator of the LAN terminal 50 that listened to the ringing tone carries out the operation of the receiving speech. As a result, the LAN terminal 50 sends to the LAN 30 the packet having a response signal as response data. This packet is received at the adapter 16 through the LAN 30, and after a protocol conversion is herein implemented, it is supplied as the response signal to the PBX 20 via the digital multiple signal line 60.

The PBX 20 that got this response signal stops sending of the RBT that has been sent to the digital multiple signal line 61 so far, and simultaneously outputs a ringing disconnection signal to the digital multiple signal line 60. The adapter 16 gets this ringing disconnection signal tone from the digital multiple signal line 60, converts into a packet, and sends this packet to the LAN 30. The LAN terminal 50 receives this packet from the LAN 30, and stops regeneration of the ringing tone from the data of the ringing disconnection signal.

Continually, the PBX 20 conducts a call connection between the multi function telephone 41 and the LAN terminal 50 in the inside thereof to enable the call of both. At this time, the voice data from the LAN terminal 50 to the multi function telephone 41 is sent to the LAN 30 as the packet from the LAN terminal 50 to the adapter 16, for which the protocol conversion is implemented within the adapter 16, and is output to the digital multiple signal line 60 for destination of the PBX 20. Also, the voice data from the LAN terminal 50 to the multi function telephone 41 is input into the adapter 16 through the digital multiple signal line 60, and after conversion into a packet within the adapter 16, it is sent to the LAN 30. This packet is received at the LAN terminal 50 through the LAN 30 and regenerated as the voice.

Next, an extension transfer process that is one of typical services of the PBX will be explained in conjunction with an arrangement diagram of FIG. 10 and a sequence diagram of FIG. 11. In FIG. 10, the case will be explained in which during the call between the multi function telephone 41 and a multi function telephone 43 via the PBX 20, the transfer process from the multi function telephone 43 to a multi function telephone 42 is executed.

At first, the operator of the multi function telephone 43 that is in a situation of calling between it and the multi function telephone 41 (step 200 of FIG. 11) pushes a hook button down (step 202 of FIG. 11). This information of pushing the hook button down is sent as the data from the multi function telephone 43 to the PBX 20 through the digital multiple signal line 63(step 207 of FIG. 11). Upon receiving this data, the PBX 20 outputs a special dial tone (SPDT) to the multi function telephone 43, and outputs a holding tone to the multi function telephone 41(step 204 of FIG. 11). Thereby, the multi function telephone 41 that has been in the calling situation (step 201 of FIG. 11) so far becomes to be in a queue situation (step 205 of FIG. 11).

Continually, the operator of the multi function telephone 43 pushes down an extension number of the multi function telephone 42 (step 206 of FIG. 11). This information of pushing the button down is sent as the data from the multi function telephone 43 to the PBX 20 through the digital multiple signal line 63 (step 207 of FIG. 11). Upon receiving this data, the PBX 20 outputs a ring-back tone (RBT) to the multi function telephone 43, and simultaneously outputs the ringing signal to the multi function telephone 42 through the digital multiple signal line 62 (step 208 of FIG. 11). The multi function telephone 43 becomes to be in the queue situation by receiving the ring-back tone (step 209 of FIG. 11).

On the other hand, upon receiving the above-mentioned ringing signal, since the multi function telephone 42 regenerates the ringing tone, the operator of the multi function telephone 42 listens to this ringing tone to pick up the ear receiver (step 210 of FIG. 11). By this operation, the multi function telephone 42 becomes to be in an off-hook situation, and sends the response signal to the PBX 20 via the digital multiple signal line 62(step 211 of FIG. 11). The PBX 20 that got the response signal stops sending of the ring-back tone to the digital multiple signal line 63,and simultaneously outputs to the digital multiple signal line 62 the ringing disconnection signal (step 212 of FIG. 11). The multi function telephone 42 that received the ringing disconnection signal from the digital multiple signal line 62 stops regeneration of the ringing tone.

Continually, the PBX 20 conducts the call connection between the multi function telephones 42 and 43 in the inside thereof to cause both to be in the situation that the call is possible (steps 213 and 214 of FIG. 11). Finally the operator of the multi function telephone 43 puts the ear receiver to cause it to be in the off-hook situation (step 215 of FIG. 11). Thereby, a clearing signal is output from the multi function telephone 43 to the PBX 20 via the digital multiple signal line 63(step 216 of FIG. 11), and the PBX 20 that received it stops outputting of the holding tone to the multi function telephone 41(step 217 of FIG. 11) and conducts the call connection between the multi function telephones 41 and 42. Thereby, the extension transfer from the multi function telephone 43 to the multi function telephones 42 is conducted, and the call between the multi function telephone 41 and the multi function telephone 42 becomes possible (steps 218 and 219 of FIG. 11).

Thus, the LAN telephone system performing the telephone service, using a LAN that has nowadays spread remarkably worldwide, is able to make the telephone network unnecessary for a user that had to install both a telephone network and a LAN as a basic information network to provide a more low-cost and unified basic information network hereto.

However, in the conventional network system that is called a LAN telephone system as set forth above, in case of causing the LAN terminal 50 to have the telephone function, since the LAN 50 itself has not been originally arranged to consider all functions of the PBX 20, the PBX 20 can not almost realize the various kinds of services, beginning with the service of the extension transfer as set forth in conjunction with FIG. 10 and FIG. 11 that has been conducted conventionally.

As a result, the service is not available such as that, conventionally, during communication between the LAN terminal 50 and the multi function telephone 41 the LAN terminal 50 has conducted the extension transfer to the other digital telephones connected to the PBX 20, and thus a user was able to utilize only the service inferior to the conventional service.

Also, in case that the user using the conventional PBX 20 introduced the LAN telephone system, since the existing digital telephones can not send and receive the packet with the predetermined format of the LAN, they were not able to be used at all and thus it was necessary to newly purchase the terminal.

### SUMMARY OF THE INVENTION

Accordingly, the objective of the present invention is to solve the above-mentioned tasks.

Moreover, the objective of the present invention is to provide an adapter apparatus that is capable of implementing a protocol conversion for the signal of the existing telephone network into the packet over the local area network and of implementing a protocol conversion for the packet from the local area network into the signal of the existing telephone network, and a network system using the same.

Also, another objective of the present invention is to provide an adapter apparatus that is capable of utilizing the local area network, using the existing digital telephones, and a network system using the same.

Also, the still further objective of the present invention is to provide an adapter apparatus that is capable of enjoying all kinds of the services of utilizing the PBX in the situation with the existing digital telephones connected to the local area, and a network system using the same.

The above-mentioned objective of the present invention is achieved by an adapter apparatus comprising: a first interface connected to a digital multiple signal line; a second interface connected to a network; a signal class detector for detecting a signal class of the input signal that was input via the first interface; packet preparation means for preparing the packet that has been obtained by implementing a first protocol conversion for the input signal that includes identification information of the signal class and that was input via the first interface based on the signal class detected by the signal class detector to send this packet to the network via the second interface; and process means for identifying the signal class from the packet input from the network via the second interface to implement a second protocol conversion for the data of the input packet responding to the identified signal class, to prepare a digital signal, and to output this digital signal to the first interface.

In the present invention, the first protocol conversion is implemented by the packet preparation means for the input signal input via the digital multiple signal line to prepare the packet that is possible to send to the network, and on the other hand, the second protocol is implemented by the process means for the input packet input from the network to convert into the signal that can be transferred with the digital multiple signal line, which can be output.

Herein, the above-mentioned packet preparation means comprise a header preparation section for preparing a header indicating identification information of the signal class based on the signal class detected by the signal class detector, a data preparation section for preparing the data that has been obtained by implementing the first protocol conversion for the input signal input via the first interface, and a packet preparation section for collecting the data from the header preparation section and the data preparation section to prepare one packet and to output it to the second interface.

Also, the above-mentioned process means comprise a header extraction section for extracting the header from the packet input from the network via the second interface, a data extraction section for extracting the data from the input packet, a signal classification data process section for identifying the signal class from the header extracted from the header extraction section to implement the second protocol conversion for the data from the data extraction section responding to this identified signal class and to output it to the first interface.

Also, the above-mentioned objective of the present invention is achieved by an adapter apparatus wherein a plurality of the first interfaces are provided, to each of the plurality of the first interfaces are connected digital multiple signal lines separately, the packet preparation means prepare the packet that includes in the header the information that to which interface out of the plurality of the first interfaces the packet is sent, the process means identify the signal class from the packet input from the network via the second interface to implement the second protocol conversion for the data of the input packet responding to the identified signal class, to prepare a digital signal, and to simultaneously output the digital signal to a designated first interface out of the plurality of the first interfaces based on the information obtained from the input packet.

In the present invention, the first protocol conversion is implemented by the packet preparation means for the input signal input via a plurality of the digital multiple signal lines to prepare the packet that is possible to send to the network, and on the other hand, the second protocol conversion is implemented by the process means for the input packet input from the network to convert into the signal that can be transferred with the plurality of the digital multiple signal lines, which is able to be output to one designated digital multiple signal line out of the plurality of the digital multiple signal lines.

Also, the objective of the present invention is achieved by a network system, wherein a first adapter implementing the protocol conversion is connected between the local area network and the digital telephone, and a second adapter implementing the protocol conversion is connected between the local area network and the private branch exchange, each of the first adapter and the second adapter comprising: a first interface being connected to the digital telephone or the private branch exchange via the digital multiple signal line; a second interface connected to the local area network; a signal class detector for detecting the signal class of the input signal input via the first interface; packet preparation means for preparing the packet that has been obtained by implementing the first protocol conversion for the input signal that includes identification information of the signal class and that was input via the first interface based on the signal class detected by the signal class detector to send this packet to the local area network via the second interface; and process means for identifying the signal class from the packet input from the local area network via the second interface to implement the second protocol conversion for the data of the input packet responding to the identified signal class, to prepare the digital signal,and to output this digital signal to the first interface.

Also, the objective of the present invention is achieved by a network system wherein a plurality of the first interfaces are provided to each of the first and the second adapters, to each of the plurality of the first interfaces are connected digital multiple signal lines separately, the packet preparation means prepare the packet that includes in the header the information that to which interface out of the plurality of the first interfaces the packet is sent, the process means identify the signal class from the packet input from the local area network via the second interface to implement the second protocol conversion for the data of the corresponding input packet responding to the identified signal class, to prepare the digital signal, and to simultaneously output the digital signal to the designated first interface out of the plurality of the first interfaces based on the information obtained from the input packet.

In the network system of the present invention, also in the case of connecting the existing digital telephone to the first adapter, since the first and the second adapters are adapted to make a mutual exchange of the protocols between the signal(the voice signal and the control data) over the digital multiple signal line and the packet over the local area network, the communication can be conducted between the private branch exchange and the existing digital telephone via the first adapter, the local area network and the second adapter.

In addition, the second adapter may be built within the private branch exchange.

Also, the digital telephone is the multi function telephone, and the private branch exchange may be connected to a plurality of the multi function telephones.

Furthermore, the above-mentioned objective of the present invention is achieved by a signal conversion method in a network system including a first interface connected to a digital multiple signal line and a second interface connected to a network, comprising the steps of: detecting a signal class of the input signal input via said first interface; preparing a packet that has been obtained by implementing the first protocol conversion for the input signal that includes identification information of the signal class and that was input via said first interface based on the detected signal class; sending said packet to said network via said second interface, and identifying the signal class from the packet input from said network via said second interface; for preparing a digital signal by implementing the second protocol conversion for the data of said input packet responding to said identified signal class; and outputting said digital signal to the first interface.

In the above-mentioned present invention, said packet preparation step comprises the steps of: preparing a header indicating identification information of the corresponding signal class based on said detected signal class; preparing the data that has been obtained by implementing said first protocol conversion for the input signal input via said first interface based on said detected signal class; and collecting said prepared data and said prepared data to prepare one packet.

Also, in the above-mentioned present invention, the step of preparing said digital signal comprises the steps of: extracting the header from the packet input from said network via said second interface; extracting the data from said input packet; and identifying the signal class from said extracted header to implement said second protocol conversion for said extracted data responding to this identified signal class.

### BRIEF DESCRIPTION OF THE DRAWING

This and other objects, features and advantages of the present invention will become more apparent upon a reading of the following detailed description and drawings, in which:

FIG. 1 is a system arrangement diagram of a first example of the present invention;

FIG. 2 is a block diagram of one embodiment of an adapter in FIG. 1;

FIG. 3 is a block diagram of one embodiment of another adapter in FIG. 1;

FIG. 4 is a flowchart for explaining an operation of an adapter in FIG. 1;

FIG. 5 is a flowchart for explaining an operation of an adapter in FIG. 1;

FIG. 6 is a system arrangement diagram of a second example of the present invention;

FIG. 7 is a block diagram of one embodiment of an adapter in FIG. 6;

FIG. 8 is a block diagram of one embodiment of another adapter in FIG. 6;

FIG. 9 is a system arrangement diagram of one conventional example;

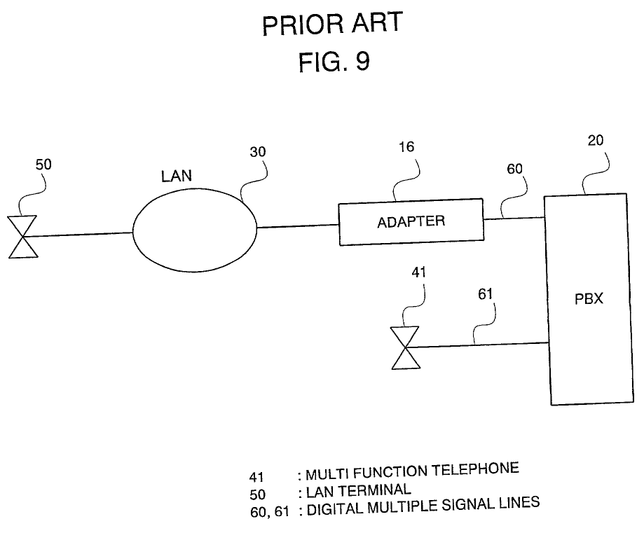

FIG. 10 is a system arrangement diagram of one example explaining an extension transfer process service of a PBX; and

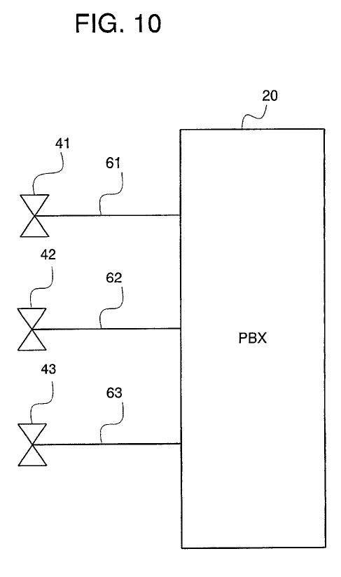

FIG. 11 is a sequence diagram for explaining an operation of FIG. 10.

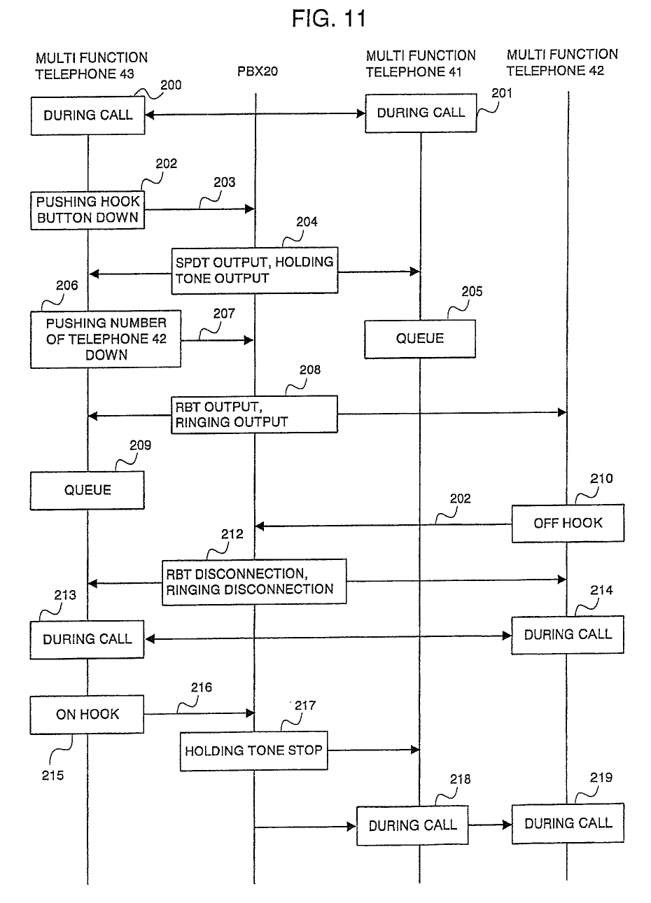

### DESCRIPTION OF THE EMBODIMENTS

An embodiment of the present invention will be explained in conjunction with the drawings.

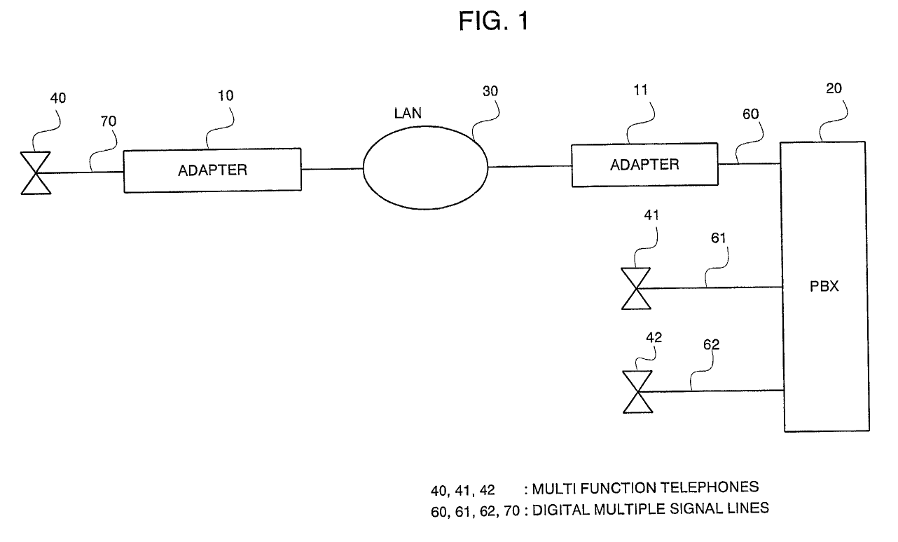

FIG. 1 is a system arrangement diagram of a first embodiment of an adapter apparatus and a network system using the same that are provided by the present invention.

In the same FIG., a LAN 30 that is one example of the existing network system is connected to an existing multi function telephone 40 via an adapter 10 and an existing digital multiple signal line 70 and at the same time connected to an existing private branch exchange (PBX) 20 via an adapter 11 and an existing digital multiple signal line 60.

Also, to the private branch exchange (PBX) 20 is connected an existing multi function telephone 41 via an existing digital multiple signal line 61 and is connected an existing multi function telephone 42 via an existing digital multiple signal line 62.

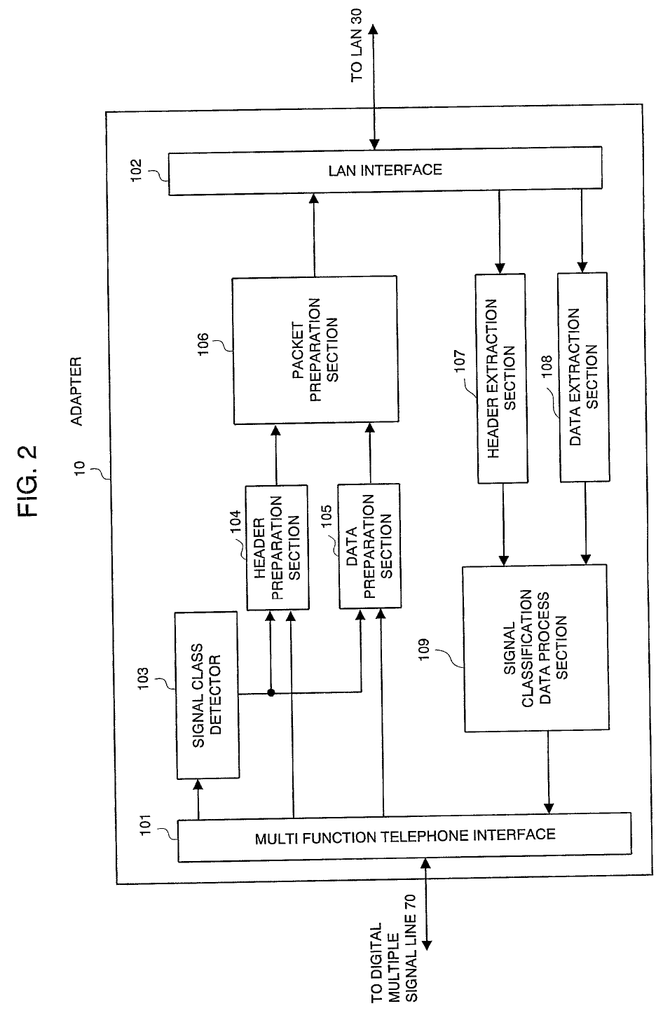

The adapter 10 is an adapter implementing a protocol conversion of the signal between the LAN 30 and the function telephone 40, and for example, is arranged as shown in a block diagram of FIG. 2. As shown in FIG. 2, the adapter 10 is connected to a digital multiple signal line 70 via a multi function telephone interface 101, and at the same time connected to the LAN 30 via a LAN interface 102.

Also, the multi function telephone interface 101 is connected to each of the input ends of a signal class detector 103, a header preparation section 104 and a data preparation section 105, and also is connected to the output end of a signal classification data process section 109. On the other hand, a LAN interface 102 is connected to the output end of a packet preparation section 106, and simultaneously connected to the input ends of a header extraction section 107 and a data extraction section 108.

The packet preparation section 106 collects the header prepared by the header preparation section 104 and the data prepared by the data preparation section 105 to convert into a packet.

Also, the signal classification data process section 109 implements a protocol conversion from the header extracted by the header extraction section 107 and the data extracted by the data extraction section 108 to determine an output tone, an output control signal or an output voice.

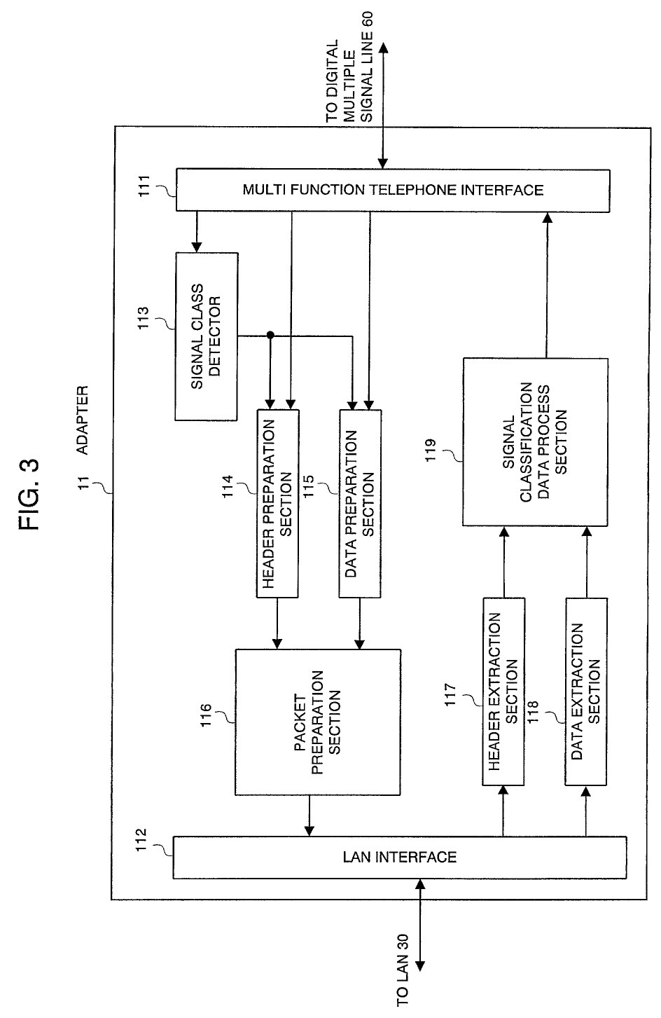

Also, the adapter 11 of the FIG. 1 is an adapter implementing a protocol conversion of the signal between the LAN 30 and the PBX 20, and for example, is arranged as shown in a block diagram of FIG. 3. As shown in FIG. 3, the adapter 11 is connected to the digital multiple signal line 60 via a multi function telephone interface 111, and at the same time is connected to the LAN 30 via a LAN interface 112.

Also, the multi function telephone interface 111 is connected to each of the input ends of a signal class detector 113, a header preparation section 114 and a data preparation section 115, and also is connected to the output end of a signal classification data process section 119.

On the other hand, a LAN interface 112 is connected to the output end of a packet preparation section 116, and simultaneously connected to the input ends of a header extraction section 117 and a data extraction section 118.

The packet preparation section 116 collects the header prepared by the header preparation section 114 and the data prepared by the data preparation section 115 to convert into a packet.

Also, the signal classification data process section 119 implements a protocol conversion from the header extracted by the header extraction section 117 and the data extracted by the data extraction section 118 to determine an output tone, an output control signal or an output voice.

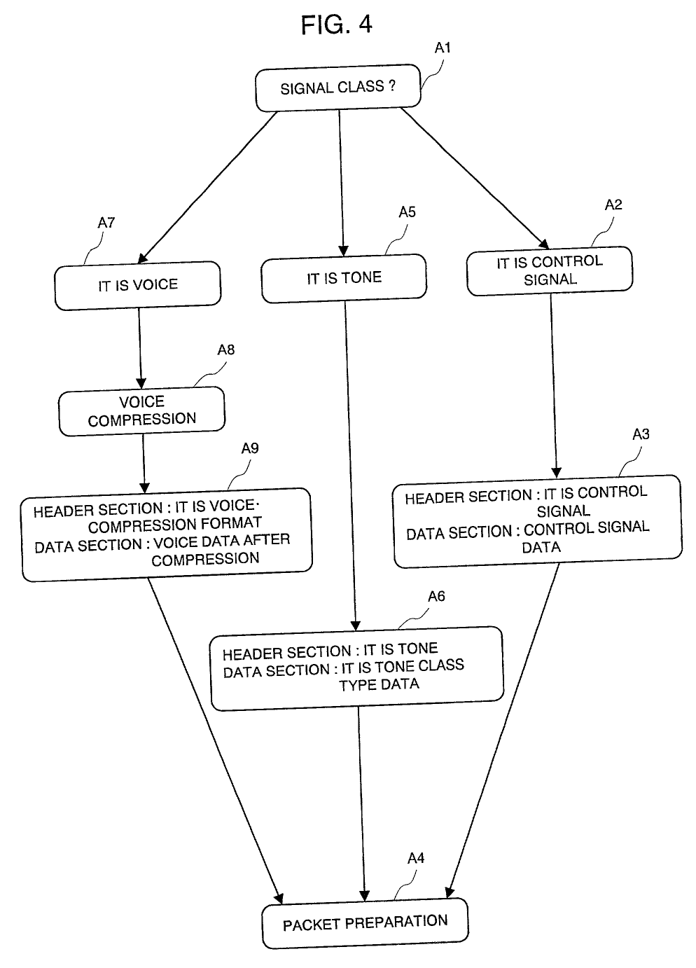

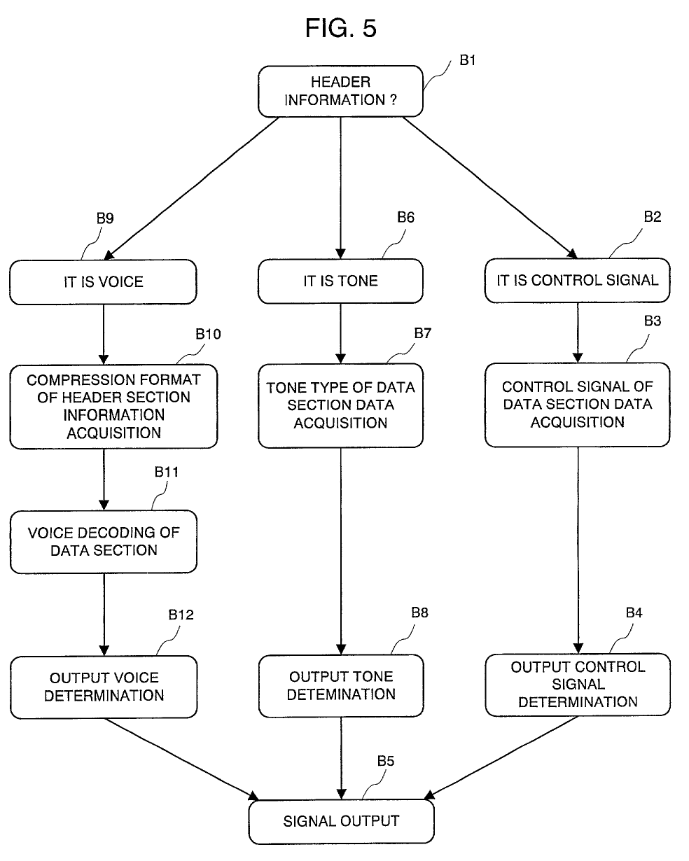

Next, the operation of the first embodiment shown in these FIG. 1 to FIG. 3 will be explained, referring to the flowcharts of FIG. 4 and FIG. 5 in addition hereto. Herein, in FIG. 1, the transfer process from the multi function telephone 40 to the multi function telephone 42, which is typically one of the processes of the PBX 20, is to be executed in the situation of the calling between the multi function telephone 41 and the multi function telephone 40.

In this case, at first, an operator of the multi function telephone 40 pushes the hook button down. This information of pushing the hook button down is supplied to the adapter 10 through the digital multiple signal line 70, and herein the packet is prepared according to the flowchart of FIG. 4. Namely, the information of pushing the hook button down is supplied to the signal class detector 103 through the multi function telephone interface 101 shown in FIG. 2 within the adapter 10, and herein the signal class is detected (step A1 of FIG. 4).

Since the above-mentioned information of pushing the hook button down is the control signal, it is detected by the signal class detector 103 that it is the control signal (step A2 of FIG. 4), and this detection result is notified to the header preparation section 104 and the data preparation section 105.

Thereby, the header preparation section 104 prepares the header indicating that it is the control signal based on the information of pushing the hook button down, which is input from the multi function telephone interface 101, and the data preparation section 105 prepares the control signal data based on the information of pushing the hook button down, which is input from the multi function telephone interface 101(step A3 of FIG. 4).

The header of the control signal output from the header preparation section 104 and the control signal data output from the data preparation section 105 are supplied to the packet preparation section 106 to prepare one packet (step A4 of FIG. 4), which is sent to the LAN 30 via the LAN interface 102.

Now coming back to FIG. 1 to explain, the adapter 11 receives via the LAN 30 the packet sent from the adapter 10 to the LAN 30, and only in case that a companion MAC (Media Access Control) address being included in the header of this packet matches its own MAC address, incorporates it into its own inside to process.

The MAC address of the adapter 11 has been written as the companion MAC address in the packet sent to the LAN 30 from the adapter 10. Accordingly, the adapter 11 receives and incorporates into the packet, which the adapter 10 sent to the LAN 30, to process it in the inside thereof according to the flowchart of FIG. 5.

Namely, the adapter 11 with the arrangement of FIG. 3 gets at the LAN interface 112 the packet, which is received from the LAN 30, and sends it to the header extraction section 117 and the header extraction section 118 respectively.

The header extraction section 117 extracts the header from the packet that was input to identify the header information (step BI of FIG. 5), recognizes that it is the header of the identification signal (step B2 of FIG. 5), and sends this effect to the signal classification data process section 119.

Also, the header extraction section 118 extracts the control signal data from the packet that was input (step B3 of FIG. 5) to send it to the signal classification data process section 119.

The signal classification data process section 119 processes the data from the header extraction section 118 according to the header information of the control signal from the header extraction section 117, and implements the protocol conversion to determine the output control signal (step B4 of FIG. 5). This control signal is sent as the information of pushing the button down to the digital multiple signal line 60 through the multi function telephone interface 111(step B5 of FIG. 5).

Once again coming back to FIG. 1 to explain, the above-mentioned information of pushing the button down is received at the PBX 20 via the digital multiple signal line 60, wherein the operation is conducted in a similar way to the conventional one, the holding tone is output to the digital multiple signal line 61 for destination of the multi function telephone 41, and the special dial tone (SPDT) is output to the digital multiple signal line 60 for destination of the multi function telephone 40. The adapter 11 receives the above-mentioned SPDT via the digital multiple signal line 60 to execute the internal process according to the flowchart of FIG. 4.

Namely, the multi function telephone interface 111 gets the input of the SPDT from the digital multiple signal line 60 within the adapter 11 shown in FIG. 3, and the signal class is detected at the signal class detector 113 (step A1 of FIG. 4). Since the above-mentioned SPDT is the tone, the signal class detector 113 detects that it is the tone (step A5 of FIG. 4), and this detection result is notified to the header preparation section 114 and the data preparation section 115.

Thereby, the header preparation section 114 prepares the header indicating that it is the tone based on the SPDT being input from the multi function telephone interface 111, and the data preparation section 115 prepares the data that includes the data that [IT IS SPDT] based on the SPDT being input from the multi function telephone interface 111(step A6 of FIG. 4). The header output from the header preparation section 114 and the data output from the data preparation section 115 are supplied to the packet preparation section 116 to prepare one packet (step A4 of FIG. 4), and sent to the LAN 30 via the LAN interface 112.

Now coming back to FIG. 1 to explain, the adapter 10 receives the packet that the adapter 11 sent to the LAN 30, confirms that the companion MAC address within this header matches its own MAC address, incorporates the packet into the inside thereof, and executes the internal process according to the flowchart of FIG. 5. Namely, the adapter 10 with the arrangement of FIG. 2 gets at the LAN interface 102 the packet received from the LAN 30, and sends it to the header extraction section 107 and the data extraction section 108.

The header extraction section 107 extracts the header from the packet that was input to identify the header information (step B1 of FIG. 5), recognizes that it is the header of the tone (step B6 of FIG. 5) and notifies the effect that [IT IS TONE] to the signal classification data process section 109. Also, the data extraction section 108 extracts the tone class data from the packet that was input (step B7 of FIG. 5), and sends it to the signal classification data process section 109.

The signal classification data process section 109 processes the data sent from the data extraction section 108 according to the header information that [IT IS TONE]from the header extraction section 107, and implements the protocol conversion to determine the output tone that [IT IS SPDT] (step B8 of FIG. 5). This output tone (SPDT) is sent to the digital multiple signal line 70 through the multi function telephone interface 101(step B5 of FIG. 5).

Once again coming back to FIG. 1 to explain, the SPDT output from the adapter 10 to the digital multiple signal line 70 is input into the multi function telephone 40, and herein pronounced. The operator of the multi function telephone 40 listens to the SPDT, and pushes down the extension number of the multi function telephone 42 to which he/she is going to transfer. This number information by pushing the button down is notified to the PBX 20 in a similar way to the foregoing information of pushing the hook button down.

The PBX 20 that received this number information by pushing the button down conducts the operation similar to the conventional one, outputs the ringing signal to the multi function telephone 42 through the digital multiple signal line 62, and conducts the operation similar to the SPDT set forth above for the multi function telephone 40 to output the ring-back tone (RBT).

Upon receiving the above-mentioned ringing signal, since the multi function telephone 42 regenerates the ringing tone, the operator of the multi function telephone 42 listens to this ringing tone to pick up the ear receiver. By this operation the multi function telephone 42 becomes to be in an off-hook situation, and sends the response signal to the PBX 20 via the digital multiple signal line 62. The PBX 20 that got the response signal outputs the ringing disconnection signal to the digital multiple signal line 62 for destination of the multi function telephone 42, and simultaneously stops outputting of the RBT to the digital multiple signal line 60 for destination of the multi function telephone 40. The multi function telephone 42 that received the ringing disconnection signal from the digital multiple signal line 62 stops the regeneration of the ringing tone.

Continually, the PBX 20, by the exchange operation in the inside thereof, conducts the call connection between the multi function telephones 40 and 42 to cause both to be in the situation that the call is possible. Namely, to the digital multiple signal line 60 is output the input voice signal from the digital multiple signal line 62 to the PBX 20, and to the digital multiple signal line 62 is output the input voice signal from the digital multiple signal line 60 to the PBX 20.

Herein, it will be explained in details how the voice signal is communicated between the multi function telephones 40 and the PBX 20. At first, it will be explained how the voice signal being input from the digital multiple signal line 60 to the PBX 20 is prepared. The voice signal input into the multi function telephone 40 is output as the digital data to the digital multiple signal line 70, and is input into the adapter 10. The adapter 10 converts into a packet the digital data that was input according to the flowchart shown in FIG. 4 to send it to the LAN 30.

Namely, in FIG. 2, the adapter 10 gets the above-mentioned digital data at the multi function telephone interface 101 via the digital multiple signal line 70, and detects the signal class at the signal class detector 103. Herein, the signal class detector 103 recognizes that the input digital data is [IT IS VOICE DATA](steps A1 and A7 of FIG. 4) and notifies this recognition information to the header preparation section 104 and the data preparation section 105. The data preparation section 105 that got this information processes for the voice coding the digital data being input via the multi function telephone interface 101 to prepare the data for the packet (step A8 of FIG. 4).

Also, simultaneously, the header preparation section 105 that got the notification that [IT IS VOICE DATA] prepares the header in which the information of it being the voice data and the format information of the voice coding are included (step A9 of FIG. 4). The packet preparation section 106 gets the header from the header preparation section 104 and the data from the data preparation section 105 prepares one packet, and sends it to the LAN interface 102 (step A4 of FIG. 4). The LAN interface 102 sends to the LAN 30 the packet that was input.

The packet that this adapter 10 output is received by the adapter 11 via the LAN 30, and incorporated into the inside thereof to process it according to the flowchart shown in FIG. 5. Namely, the adapter 11 with the arrangement of FIG. 3 gets at the LAN interface 112 the packet from the LAN 30, and sends it to the header extraction section 117 and the data extraction section 118. The header extraction section 117 detects from the header extracted from the packet that the data within the packet is [IT IS VOICE SATA] (steps B1 and B9 of FIG. 5), and obtains the information on which compressed format is used for coding (step B10 of FIG. 5). The header extraction section 117 notifies the signal classification data process section 119 of this obtained information.

The signal classification data process section 119 decodes the data within the packet extracted at the data extraction section 118 (step B11 of FIG. 5) based on the information notified from the header extraction section 117, determines the output voice data (step B12 of FIG. 5), and sends it to the multi function telephone interface 111. The multi function telephone interface 111 outputs to the digital multiple signal line 60 the voice data that was input (step B13 of FIG. 5). This output voice data is input into the PBX 20.

Next, it will be explained how the voice signal output from the PBX 20 to the digital multiple signal line 60 is regenerated as the voice at the multi function telephone 40. The voice signal sent from the PBX 20 to the digital multiple signal line 60 is input into the adapter 11, and the process is executed for the protocol conversion thereof into the signal format to be output to the LAN 30 in the inside of the adapter 11 according to the flowchart shown in FIG. 4.

Namely, the adapter 11 shown in FIG. 3 gets the voice signal from the digital multiple signal line 60 at the multi function telephone interface 111, and detects the signal class at the signal class detector 113. Herein, the signal class detector 113 recognizes that the input signal is [IT IS VOICE SIGNAL] (steps A1 and A7 of FIG. 4) and notifies the header preparation section 114 and the data preparation section 115 of this recognition information. The data preparation section 115 that got this information processes the voice signal being input via the multi function telephone interface 111 for voice compressing and coding to prepare the data for the packet (step A8 of FIG. 4).

Also, simultaneously, the header preparation section 115 that got the notification that [IT IS VOICE SIGNAL] prepares the header in which the information of it being the voice signal and the format information of the voice coding are included (step A9 of FIG. 4). The packet preparation section 116 gets the header from the header preparation section 114 and the data from the data preparation section 115 to prepare one packet and to send it to the LAN interface 112(step A4 of FIG. 4). The LAN interface 112 sends to the LAN 20 the packet that was input.

The packet that this adapter 11 output is received at the adapter 10 via the LAN 30, and is incorporated into the inside thereof to process it according to the flowchart shown in FIG. 5. Namely, the adapter 10 with the arrangement of FIG. 2 gets at the LAN interface 102 the packet from the LAN 30, and sends it to the header extraction section 107 and the data extraction section 108. The header extraction section 107 detects from the header extracted from the input packet that the data within the packet is [IT IS VOICE DATA] (steps B1 and B9 of FIG. 5), and obtains the information on which compressed format is used for coding (step B10 of FIG. 5). The header extraction section 107 notifies the signal classification data process section 109 of this obtained information.

The signal classification data process section 109 decodes the data within the packet extracted at the data extraction section 108 based on the information notified from the header extraction section 107 (step B10 of FIG. 5), determines the output voice data (step B12 of FIG. 5), and sends it to the multi function telephone interface 101. The multi function telephone interface 101 outputs to the digital multiple signal line 70 the voice data that was input (step B13 of FIG. 5). The voice data output to the digital multiple signal line 70 is input into the multi function telephone 40. Thereby, the operator of the multi function telephone 40 can listen to the voice output from the PBX 20 to the digital multiple signal line 60.

Finally, the operator of the multi function telephone 40 puts the ear receiver as is in the above-mention situation in order to get the transfer service. Thereby, the multi function telephone 40 becomes to be in the on-hook situation, and sends the clearing signal over the digital multiple signal line 70 for destination of the PBX 20. The clearing signal sent over the digital multiple signal line 70 is notified to the PBX 20 in the procedure similar to the foregoing information of pushing the hook button down.

The PBX 20 that received the clearing signal stops outputting of the holding tone to the multi function telephone 41, and by the internal exchange operation, enables the call between the multi function telephones 41 and 42. Namely to the digital multiple signal line 61 is output the input voice signal from the digital multiple signal line 62 to the PBX 20, and to the digital multiple signal line 62 is output the input voice signal from the digital multiple signal line 61 to the PBX 20. Thereby, the transfer process from the multi function telephone 40 to the multi function telephone 42 finishes.

Thus, in accordance with the present embodiment, by the adapters 10 and 11, by implementing the conversion into the packet/from the packet the conventional data over the signal line between the PBX-the multi function telephone, the PBX service through the LAN 30 is possible to get. Accordingly, the telephone network is removed from basic information network, and even though the LAN is introduced, the existing multi function telephones and so forth can be used, and yet the very service can be enjoyed as it is.

Also, since the existing terminals such as the multi function telephones and so forth can be utilized, it is possible to proceed to an introduction of the LAN at a low cost.

Next, the second embodiment of the present invention will be explained.

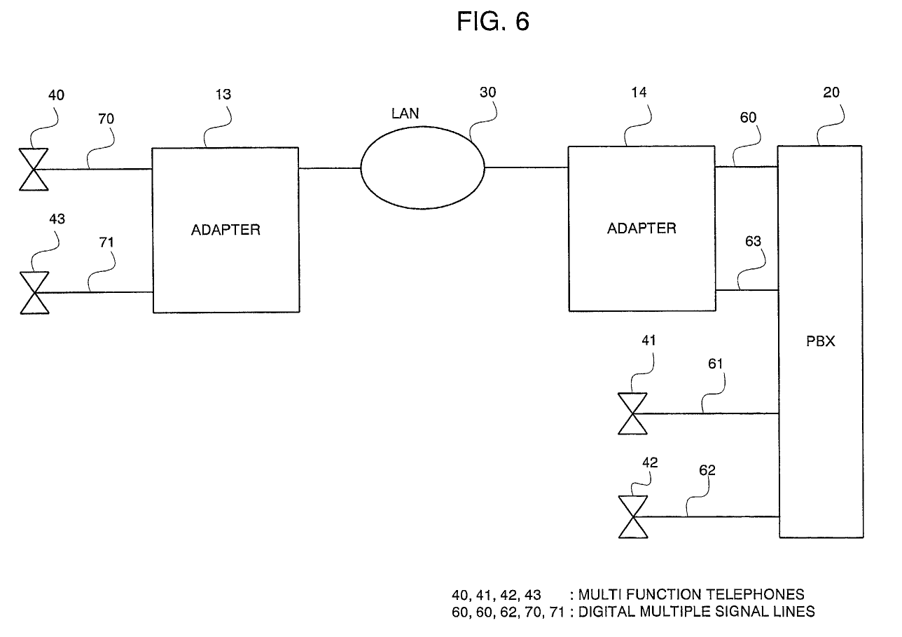

FIG. 6 illustrates a system arrangement diagram of the second embodiment of the adapter apparatus and the network system using the same, which are provided by the present invention. In the same fig., to the same arrangement elements as FIG. 1 are attached the same identification numbers. In FIG. 6, an adapter 13 is connected to the two multi function telephones 40 and 43 through digital multiple signal lines 70 and 71. Also, an adapter 14 is connected to the PBX 20 via the digital multiple signal lines 60 and 63. Further, the adapter 13 and the adapter 14 are connected via the LAN 30.

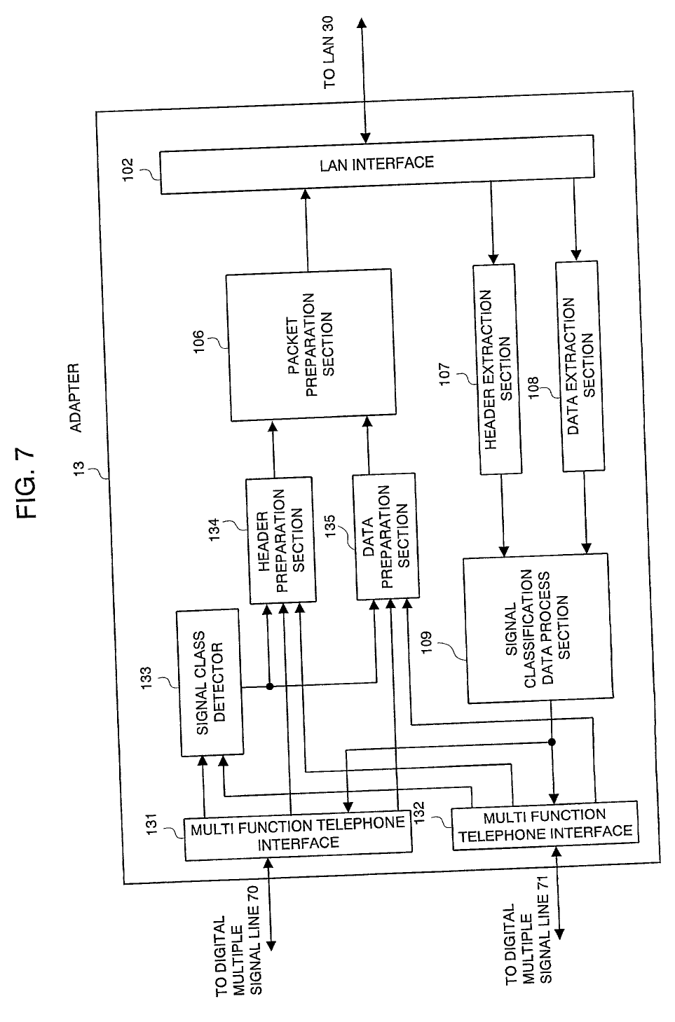

The adapter 13, for example, is arranged as shown in the block diagram of FIG. 7. In the same FIG., to the same arrangement elements as FIG. 2 are attached the same identification numbers, and the explanation thereof is omitted.

In FIG. 7, the adapter 13 is connected to a digital multiple signal line 70 via a multi function telephone interface 131, and also is connected to a digital multiple signal lines 71 via a multi function telephone interface 132, and at the same time is connected to the LAN 30 via the LAN interface 102.

Also, each of multi function telephone interfaces 131 and 132 is connected to each of the input ends of a signal class detector 133, a header preparation section 134 and a data preparation section 135 respectively, and also is connected to the output end of the signal classification data process section 109.

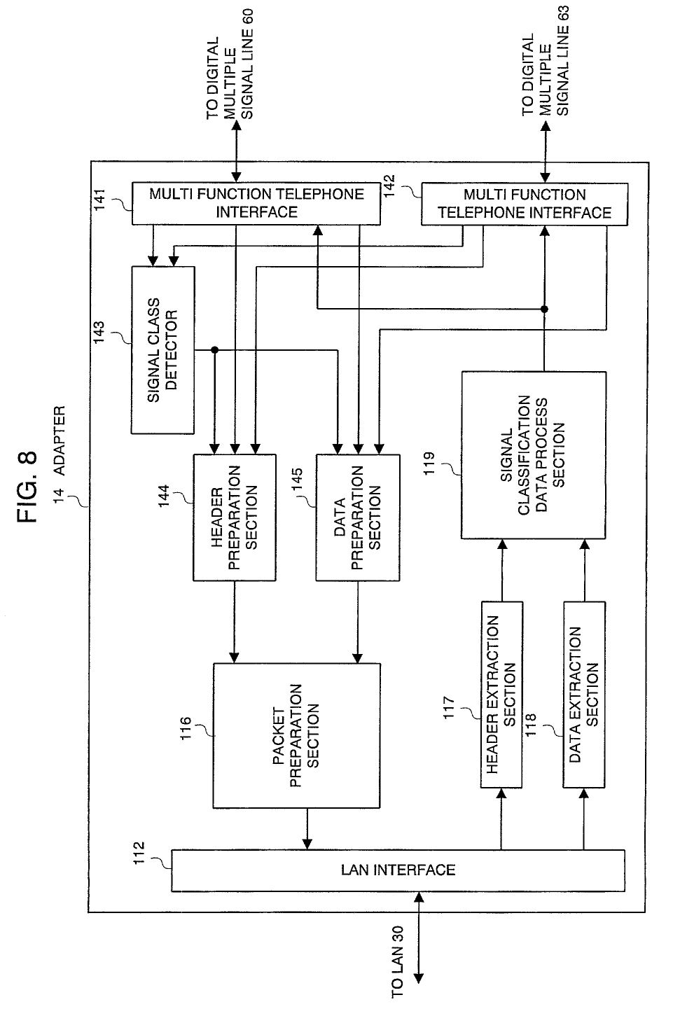

The adapter 14, for example, is arranged as shown in the block diagram of FIG. 8. In the same FIG., to the same arrangement elements as FIG. 3 are attached the same identification numbers, and the explanation thereof is omitted.

In FIG. 8, an adapter 14 is connected to a digital multiple signal line 60 via a multi function telephone interface 141,also is connected to a digital multiple signal lines 63 via a multi function telephone interface 142, and at the same time is connected to the LAN 30 via the LAN interface 112.

Also, each of multi function telephone interfaces 141 and 142 is connected to each of the input ends of a signal class detector 143, a header preparation section 144 and a data preparation section 145 respectively, and also is connected to the output end of the signal classification data process section 119.

Next, the operation of the second embodiment shown in these FIG. 6 to FIG. 8 will be explained.

In case of sending the control signal (the clearing signal and so forth) and the voice signal from the PBX 20, for example, to the multi function telephone 40, the PBX 20 sends the signal to the digital signal line 60 to which the multi function telephone 40 seems to be connected. The adapter 14 needs to install the information that to which multi function telephone the signal is sent during the procedure of receiving the signal from this PBX 20 and of sending the packets to the LAN 30.

Therefore, within the adapter 14 with the arrangement shown in FIG. 8, when the header is prepared in a header preparation section 144, this information is installed in the header. The packet sent from the adapter 14 to the LAN 30 is received at the adapter 13 through the LAN 30, and the recognition is made at the header extraction section 134 shown in FIG. 7 within the adapter 13 that to which multi function telephone the signal is sent and to which port this multi function telephone is connected. Herein, as the output port is selected the port to which the digital multiple signal line 70 is connected, and the signal from the digital multiple signal line 70 to the PBX 20 via the multi function telephone interface 131 is output.

On the contrary, in case of sending the signal from the multi function telephone 40 to the PBX 20, it is installed as the header information at the header preparation section 134 within the adapter 13 that from which multi function telephone connected to the adapter 13 the signal comes. The packet sent from the adapter 13 to the LAN 30 is received at the adapter 14 via the LAN 30, and the recognition is made at the header extraction section 117 shown in FIG. 8 within the adapter 14 that from which multi function telephone the signal comes and to which port connected to the adapter 14 the signal has to be output. Herein, the digital multiple signal line 60 is selected as the output port, and thereby the signal from the multi function telephone 40 is sent to the PBX 20.

As a result, in case that two set of the multi function telephones 40 and 43 are connected to one adapter 13, the operation is possible. Similarly, by increasing the number of the digital signal lines being connected to the adapter, also in case that much more set of the multi function telephones are connected, the service can be performed.

In addition, the present invention is not limited to the embodiments above, for example, the voice that is sent by converting into the packet over the LAN 30 can find the various methods for voice coding/decoding within the adapters 10,11,13 or 14, or the process for voice coding/decoding may not be executed.

Also, in the embodiments above, the information of the header section and the information of the data section are explained separately, but it is necessary only that the necessary information is finally included within the packet. Namely, the method for separation of the information of the header section and the information of the data section may differ from that of the embodiments.

Also, the adapters 11 and 14 on the PBX 20 side may be permissibly built within the PBX 20.

Further, the outputting of the tone sound may not be limited to the adapter. Namely, a tone generator may be permissibly provided to the terminal itself such as the multi function telephone and so forth, and the arrangement is permissible in which the tone sound from the tone generator within the PBX 20 is transferred to cause the operator of the multi function telephone to listen hereto.

Furthermore, in the above-mentioned embodiments, the multi function telephone having the multi functions (For example, a time display, a companion number display, transfer, holding, one touch dialing and so forth) is used among the digital telephones, but of course the digital telephone without the multi function can find application in the present invention, and the other computer data and the video signal than the voice signal can also be applied for the signal to be sent.

As explained above, in accordance with the present invention, since the first protocol conversion is adapted to be implemented for the input signal input via the digital multiple signal line to prepare the packet that is possible to send to the network, and on the other hand, the second protocol conversion is adapted to be implemented for the input packet input from the network to convert into the signal that can be transferred with the digital multiple signal line and to output it, the communication can be made between the digital telephone such as the existing multi function telephone and so forth and the exchange via the network, and yet the service can be enjoyed of utilizing the existing private branch exchange in the situation of having been connected to the existing network.

Also, in accordance with the present invention, in case of changing the existing telephone network to the local area network (LAN), since the existing information terminals can be used as they are, it is possible to shift at a low cost.

Also, in accordance with the network system of the present invention, by using the adapter apparatuses of the above-mentioned invention as a first adapter that is connected between the digital telephone such as the multi function telephone and so forth and the local area network to implement the protocol conversion and, a second adapter that is connected between the local area network and the private branch exchange to implement the protocol conversion, the information terminals such as the existing multi function telephones and so forth can be connected to the local area network (LAN), and all kinds of the services of utilizing the existing private branch exchange in the situation of having been connected to the LAN.

The entire disclosure of Japanese Patent No.2000-127065 filed on Apr. 27, 2000 including specification, claims, drawing and summary are incorporated herein by reference in its entirety.

What is claimed is:

1. An adapter apparatus, comprising:
a first interface connected to a digital multiple signal line;
a second interface connected to a network;
a signal class detector for detecting a signal class of an input signal input via said first interface;
packet preparation means for preparing a packet that has been obtained by implementing a first protocol conversion for said input signal that includes identification information of said corresponding signal class and that was input via said first interface based on said signal class detected by said signal class detector to send this packet to said network via said second interface; and
process means for identifying a signal class from said packet input from said network via said second interface to implement a second protocol conversion for data of said corresponding input packet responding to said identified signal class, to prepare a digital signal, and to output this digital signal to said first interface.

2. The adapter apparatus according to claim 1, wherein said packet preparation means comprise:
a header preparation section for preparing a header indicating identification information of said corresponding signal class based on said signal class detected by said signal class detector; a data preparation section for preparing data that has been obtained by implementing said protocol conversion for said input signal input via said first interface based on said signal class detected by said signal class detector; and
a packet preparation section for collecting said data from said header preparation section and said data from said data preparation section to prepare one packet and to output it to said second interface.

3. The adapter apparatus according to claim 1, wherein said process means comprise:
a header extraction section for extracting a header from said packet input from said network via said second interface;
a data extraction section for extracting data from said input packet; and
a signal classification data process section for identifying a signal class from said header extracted from said header extraction section to implement said second protocol conversion for said data from said data extraction section responding to this identified signal class and to output it to said first interface.

4. The adapter apparatus according to claim 1, wherein said network is a local area network, to said first interface is connected anyone of a multi function telephone or a private branch exchange via said digital signal line, and
said signal class detector detects that said signal class is anyone of a control signal, a tone signal, and a voice signal.

5. The adapter apparatus according to claim 1, wherein a plurality of said first interfaces are provided,
to each of said plurality of said first interfaces are connected digital multiple signal lines separately,
said packet preparation means includes means for preparing a packet that includes in a header information that to which interface out of said plurality of said first interfaces said packet is sent, and
said process means includes means for identifying a signal class from said packet input from said network via said second interface to implement a second protocol conversion for data of said corresponding input packet responding to said identified signal class, to prepare a digital signal, and to simultaneously output said digital signal to a designated first interface out of said plurality of said interfaces based on information obtained from said input packet.

6. A network system, wherein a first adapter implementing a protocol conversion is connected between a local area network and a digital telephone, and a second adapter implementing a protocol conversion is connected between said local area network and a private branch exchange,
each of said first adapter and said second adapter comprising:
a first interface being connected to said digital telephone or said private branch exchange via a digital multiple signal line;
a second interface connected to said local area network;
a signal class detector for detecting a signal class of an input signal input via said first interface;
packet preparation means for preparing a packet that has been obtained by implementing a first protocol conversion for said input signal that includes identification information of said corresponding signal class and that was input via said first interface based on said signal class detected by said signal class detector to send this packet to said local area network via said second interface; and
process means for identifying a signal class from said packet input from said local area network via said second interface to implement a second protocol conversion for data of said corresponding input packet responding to said identified signal class, to prepare a digital signal, and to output this digital signal to said first interface.

7. The network system according to claim 6, wherein a plurality of said first interfaces are provided to each of said first and said second adapters,
to each of said plurality of said first interfaces are connected digital multiple signal lines separately,
said packet preparation means includes means for preparing a packet that includes in a header information that to which interface out of said plurality of said first interfaces said packet is sent, and
said process means includes means for identifying a signal class from said packet input from said local area network via said second interface to implement a second protocol conversion for data of said corresponding input packet responding to said identified signal class, to prepare a digital signal, and to simultaneously output said digital signal to a designated first interface out of said plurality of said first interfaces based on information obtained from said input packet.

8. The network system according to claim 6, wherein said second adapter has been built within said private branch exchange.

9. The network system according to claim 6, wherein said digital telephone is a multi function telephone, and said private branch exchange is connected to a plurality of multi function telephones.

10. A signal conversion method in a network system including a first interface connected to a digital multiple signal line and a second multiple line connected to a network, comprising the steps of:
detecting a signal class of an input signal input via said first interface;
preparing a packet that has been obtained by implementing a first protocol conversion for said input signal that includes identification information of this signal class and that was input via said first interface based on said detected signal class;
sending said packet to said network via said second interface;
identifying a signal class from said packet input from said network via said second interface;
implementing a second protocol conversion for data of said input packet responding to said identified signal class to prepare a digital signal; and
outputting said digital signal to said first interface.

11. The signal conversion method in a network system according to claim 10, wherein said step of preparing said packet comprises the steps of:
preparing a header indicating identification information of said corresponding signal class based on said detected signal class;
preparing data that has been obtained by implementing said first protocol conversion for said input signal input via said first interface based on said detected signal class; and
collecting said prepared header and said prepared data to prepare one packet.

12. The signal conversion method in a network system according to claim 10, wherein said step for preparing said digital signal comprises the steps of:
extracting a header from said packer input from said network via said second interface;
extracting data from said input packet; and
identifying a signal class from said extracted packet to convert into said second protocol said extracted data responding to this identified signal class.
